(19) United States
(12) Patent Application Publication
(10) Pub. No.: US 2024/0241333 A1
(43) Pub. Date: Jul. 18, 2024

(54) LED INTERCONNECT WITH BREAKOUT FOR MEMORY APPLICATIONS

(71) Applicants: Bardia Pezeshki, Sunnyvale, CA (US); Kaveh Pezeshki, Sunnyvale, CA (US)

(72) Inventors: Bardia Pezeshki, Sunnyvale, CA (US); Kaveh Pezeshki, Sunnyvale, CA (US)

(21) Appl. No.: 18/415,334

(22) Filed: Jan. 17, 2024

Related U.S. Application Data
(60) Provisional application No. 63/439,360, filed on Jan. 17, 2023.

(51) Int. Cl. G02B 6/43; H04B 10/80

(52) U.S. Cl. CPC G02B 6/43; H04B 10/801

(57) ABSTRACT

Processors may be coupled to memory using microLED interfaces and fiber bundles. The fiber bundles may include sub-bundles coupled to different chips providing the memory. The microLED interfaces may be implemented on and/or in chips providing the processors or memory. The processors may be separate processors, a processor with multiple cores, or provide a neural network accelerator.

### CROSS-REFERENCE TO RELATED APPLICATIONS

This application claims the benefit of U.S. Provisional Patent Application No. 63/439,360, filed on Jan. 17, 2023, the disclosure of which is incorporated by reference herein.

### FIELD OF THE INVENTION

The present invention relates generally to optical interconnects for data communication, and more particularly to optical interconnects for memory applications.

### BACKGROUND OF THE INVENTION

Limited data connectivity to digital ICs is now a significant bottleneck for computing. Over the last few decades, the speed of data processing (arithmetic) has increased much more rapidly than the ability to move the data across a chip, between chips, and across circuit boards. The problem is particularly acute between processors and memory. Though optics has long been seen as a potential solution to ease this bottleneck, almost all short distance data connections are still electrical.

Specifically, there is a trade-off between the amount of memory that can be accessed and how fast data can be transferred from memory. The drivers are the fundamentally poor density of memory compared to logic, and the bandwidth and latency penalties associated with putting memory further away from the logic.

The two memory technologies that dominate the market today are dynamic random-access memory (DRAM) and static random-access memory (SRAM). SRAM has poor density (KiB-MiB), requiring 6-10 transistors per bit, but offers a very low latency of ˜1 ns. In contrast, DRAM provides much higher density (GiB-TiB), requiring only a single transistor per cell, but with latency of ˜100 ns. DRAM state also decays and so must be ‘refreshed’ after readout. Furthermore, DRAM processes are incompatible with standard CMOS logic, and so the two cannot be easily integrated into the same chip.

The disparity in latency and density between memory technologies has driven the development of ‘memory hierarchy’. It is critical for arithmetic units in a processor to have approximately single-cycle access to some memory, so small blocks of very low latency and very low-density SRAM are placed where computation occurs on a chip. This is known as Level 1 (L1) cache. Larger blocks of higher density and higher latency SRAM are placed further away from arithmetic units and are typically shared between different processing units on a single chip. These are known as L2 and L3 cache. Latency is driven by both the SRAM cell and RC (resistance-capacitance) delay through the SRAM—logic interconnect. The memory control unit of the processor tries to load instructions and data from main memory into L1—L3 cache before it is needed, to avoid costly fetches from main memory. The ‘hit rate’ of a cache describes the proportion of memory requests that return data from the cache.

FIG. 1 shows a typical architecture of a multicore processor with the different levels of cache. A processor die 111 includes a plurality of processor cores 115a-n. Each core includes circuitry, e.g., circuitry 117a for a first processor core 115a, for performing logic and related functions. Each core has its own L1 and L2 cache, e.g., 119a1,a2 and 121, respectively. An L3 cache 123 is shared between cores. It is typical for L1 to have a ‘split’ design, with a separate instruction cache 119a1 and data cache 119a2. This provides higher bandwidth in exchange for a reduction in hit rate. The processor moves through the caches hierarchically: if an instruction or data is not found in L1 cache, it searches the L2 and then L3 caches. If the data cannot be found in any of the caches, then the processor accesses the main memory, leading to delays of several hundred clock cycles. Increasing cache size increases hit rate in exchange for higher latency, as larger caches require denser and slower cells in addition to longer interconnects. There are many tunable parameters beyond cache size, such as the size of the ‘block’ transferred between cache and main memory, and the associativity, or the number of ways to store a block in the cache. It is also common to split a single cache into multiple independent ‘slices’ to increase bandwidth. This cache hierarchy relies on assumptions of locality: that data accessed at some memory address x at some time t increases the probability of an access near x at time t+1. If there are strong spatial and temporal correlations in memory access, cache sizes can be small while maintaining high hit rates.

Contemporary lithography can integrate only ˜100 MiB of SRAM on a processor die, insufficient for standard workloads. One solution is to integrate a small amount of low-latency embedded DRAM (eDRAM) on a multi-chip module (MCM) with the processor. However, the most widely used approach combines fast on-chip SRAM with a large pool of high-latency off-chip DRAM 113. This DRAM is typically several centimeters away from the processor, on a pluggable module. Due to the challenges of routing many high-speed lanes into a CPU package, the wide DRAM bus is typically serialized into a few very high-speed lanes, and deserialized in the processor memory controller. Furthermore, the large distances between the processor and memory as well as package-PCB crossings may necessitate equalization or forward error correction of the memory bus that also increases power consumption and latency. With standard DDR DRAM, hundreds of GiB to TiB of memory can be integrated into a single system, but with now hundreds of nanoseconds of delay.

Improved latency and higher bandwidth can be realized by stacking DRAM chips on top of each other to form High-Bandwidth Memory (HBM). This memory stack is then co-packaged with logic on a silicon interposer, which allows for dense arrays of electrical interconnects forming a wide bus. The shorter distances and tighter interconnect pitch offered by the interposer removes the need for a SERializer/DESerializer (SERDES), therefore improving latency to ˜100 ns and reducing power consumption. But the HBM stacks are difficult to manufacture, are expensive, and the limited area of a silicon interposer restricts the amount of memory that can be integrated with logic. Furthermore, the proximity of the memory stack and processor leads to high memory temperatures, which increases leakage in DRAM cells, effectively slowing the memory by increasing refresh frequency.

Another approach which provides higher amounts of fast cache is to use advanced packaging to stack the memory on the chip. FIG. 2 is a diagram of a 3D cache architecture with memory stacked on a processor chip. In FIG. 2 a 64 MB SRAM chip 215 is mounted directly on top of a processor 211, acting like an L3 cache which is shared by all the cores. The processor may be on a printed circuit board 213, with blank tiles 217a,b on either side of the processor. Since the memory is directly on top of the processor and connected with through silicon vias (TSVs), there is no need to move data across the chip to the periphery for input/output, and access becomes faster. In some embodiments, this stacking may effectively triple the size of the L3 cache, and because the chip is intimately integrated, only 4 clock cycles of latency may be added. This implementation therefore maintains the advantages of on-chip SRAM over DRAM. However, the total SRAM area is still limited by the size of the logic dies and the package, so the amount of memory offered by this stacked architecture is limited. A naïve solution is to use a large package and logic die, offering a large area for SRAM. This, however, requires long electrical interconnects across the memory and logic dies, which would limit frequency and dominate power. HBM can also be stacked beside or on top of a processor chip and would have the advantage of higher density, but as previously mentioned, HBM has intrinsically higher latency, and has issues with the high temperature environment of a processor package.

Other types of memories, such as flash or hard drive magnetic storage have latencies of microseconds to milliseconds but can store many TiB of data.

The traditional cache hierarchy described above works well for typical general-purpose architectures but fails in specialized tasks which do not follow the assumptions of spatial and temporal locality. One example of this is bulk matrix multiplication, which is the central component of neural network training and inference. Here, the hierarchical set of small, non-uniform memories offered by the traditional cache system inefficiently captures the large, homogenous set of weights and intermediate results used in matrix multiplication. Advanced packaging, like the 3D cache architecture described above, can provide order-of-magnitude increases in cache size, but the size and thermal restrictions imposed by the die and package restricts the total amount of memory. Alternative architectures, like large homogenous “scratch pads” with low latency would be very beneficial—but cannot easily be implemented in hardware.

### BRIEF SUMMARY OF THE INVENTION

Some embodiments provide a means of connecting a processor to memory that provides:
1) Long interconnect distance without added latency
2) Different fabrication processes for logic and memory
3) Highly parallel with lane speed>=processor clock

In some embodiments the interconnect allows for large amounts of low-latency, low-density memory to be connected to a single processor, allowing for very large caches, and effectively flattening the memory hierarchy.

Some embodiments provide a system including a memory optical interconnect, comprising: a processor chip including logic for interfacing with memory; a first array of microLEDs on the processor chip; a first array of photodetectors on the processor chip; a plurality of memory chips; and a fiber bundle including a plurality of sub-bundles of fibers, with the fibers of some of the sub-bundles optically coupled to the first array of microLEDs and fibers of others of the sub-bundles optically coupled to the first array of photodetectors, and with fibers of different ones of the sub-bundles optically coupling different ones of the memory chips and the processor chip. In some embodiments the memory chips comprise static random-access memory (SRAM) chips. In some embodiments the processor chip is mounted to a substrate, with the fiber bundle routed through an aperture in the substrate. In some embodiments the first array of microLEDs and the first array of photodetectors are on an active surface of the processor chip. In some embodiments a heatsink and cooling fins are coupled to an inactive surface of the processor chip. In some embodiments fibers of two different sub-bundles optically couple each memory chip and the processor chip. In some embodiments a first of the two different sub-bundles provides for communication in a first transmit/receive direction and a second of the two different sub-bundles provides for communication in a second transmit/receive direction. In some embodiments the processor chip and the memory chips are on different substrates.

Some embodiments provide a system including a processor optically connected to memory, comprising: a processor chip including a plurality of processor cores, cache memory for each processor core, shared cache memory for the processor cores, and a first microLED interface; at least one first memory electrically coupled to the processor chip; at least one second memory electrically coupled to a second microLED interface; the first microLED interface and the second microLED interface each comprising microLEDs, drive circuitry for the microLEDs, photodetectors, and read-out circuitry for the photodetectors; and at least one optical fiber bundle, the at least one optical fiber bundle coupling the microLEDs of the first microLED interface with photodetectors of the second microLED interface and coupling the microLEDs of the second microLED interface with photodetectors of the first microLED interface. In some embodiments the second memory is directly mapped to a subset of address space of the processor core. In some embodiments the first memory comprises dynamic random-access memory (DRAM) and the second memory chip comprises static random-access memory (SRAM). In some embodiments the first microLED interface of the processor chip is coupled to the processor cores such that processor core access to the second memory bypasses a hierarchy defined by the cache memory and shared cache memory of the processor chip. In some embodiments the first microLED interface of the processor chip is coupled to the processor cores by way of the cache memory and the shared cache memory of the processor chip. In some embodiments the first microLED interface of the processor chip is coupled to the shared cache memory of the processor chip. In some embodiments the at least one optical fiber bundle includes a plurality of sub-bundles, each sub-bundle including fibers interfaced with an independent region of the second memory.

Some embodiments provide a neural network accelerator memory interconnect, comprising: a plurality of first microLED interfaces on a neural network (NN) accelerator chip, the accelerator chip comprising a host interface for communication with a central processing unit (CPU) and blocks for performing matrix multiplication and arithmetic logic unit; at least one second microLED interface coupled to memory external to the NN accelerator chip; with the plurality of first microLED interfaces and the at least one second microLED interface each comprising microLEDs, drive circuitry for the microLEDs, photodetectors, and read-out circuitry for the photodetectors; and at least one optical fiber bundle, the at least one optical fiber bundle coupling the microLEDs of the plurality of first microLED interfaces with photodetectors of the at least one second microLED interface and coupling the microLEDs of the at least one second microLED interface with photodetectors of the plurality of first microLED interfaces. In some embodiments a first of the plurality of first microLED interfaces is associated with computation weights, a second of the plurality of first microLED interfaces is associated with results of matrix multiplication by the NN accelerator chip, and a third of the plurality of first microLED interfaces is associated with intermediate results determined by the NN accelerator chip.

Some embodiments provide a many-to-one high bandwidth memory interconnect, comprising: a plurality of first microLED interfaces coupled to a plurality of CPUs, with at least one of the plurality of first microLED interfaces packaged on or with each CPU die; at least one second microLED interface coupled to high bandwidth memory external to the CPU die; with the plurality of first microLED interfaces and the at least one second microLED interface each comprising microLEDs, drive circuitry for the microLEDs, photodetectors, and read-out circuitry for the photodetectors; and at least one optical fiber bundle, the at least one optical fiber bundle coupling the microLEDs of the plurality of first microLED interfaces with photodetectors of the at least one second microLED interface and coupling the microLEDs of the at least one second microLED interface with photodetectors of the plurality of first microLED interfaces.

These and other aspects of the invention are more thoroughly comprehended upon review of this disclosure.

### BRIEF DESCRIPTION OF THE FIGURES

FIG. 1 shows an architecture of a multicore processor with different levels of cache.

FIG. 2 is a diagram of a cache architecture with memory stacked on a processor chip.

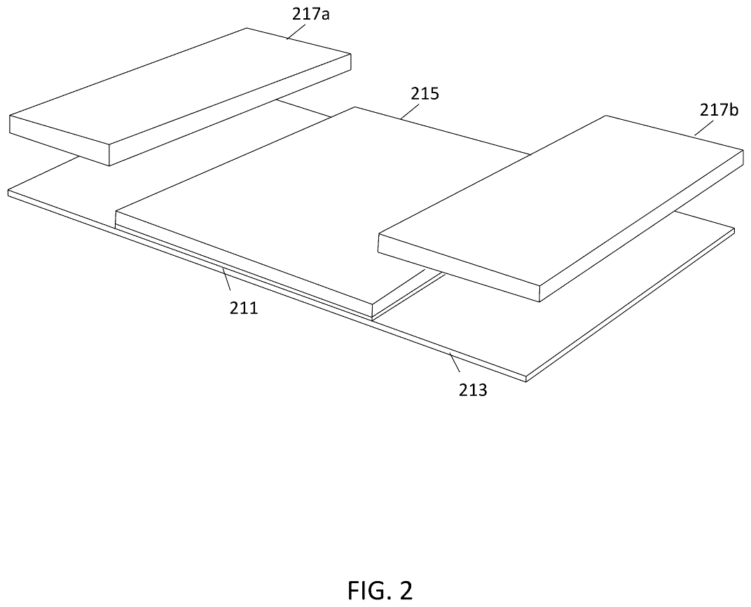

FIGS. 3A diagrammatically and FIG. 3B in block diagram show an example architecture in accordance with aspects of the invention.

FIG. 4 illustrates an implementation of microLEDs and PDs on a processor die, in accordance with aspects of the invention.

FIG. 5 illustrates an example system implementing an optical interconnect in accordance with aspects of the invention.

FIG. 6 is a block diagram of an architecture in which a GiB-scale SRAM is directly mapped to some subset of address space of or associated with a processor, in accordance with aspects of the invention.

FIG. 7 is a block diagram of an architecture in which a large off-chip SRAM is effectively placed within a cache hierarchy, in accordance with aspects of the invention.

FIG. 8 illustrates an example implementation including an L3 SRAM cache, in accordance with aspects of the invention.

FIG. 9 is a block diagram of a neural network (NN) accelerator implementing an external optically addressed SRAM, in accordance with aspects of the invention.

FIG. 10 illustrates an example implementation of a SRAM, along with the NN accelerator, in accordance with aspects of the invention.

FIG. 11 is a semi-block diagram of a system including a plurality of CPU optically interfaced with common memory, in accordance with aspects of the invention.

### DETAILED DESCRIPTION

### Interconnect Overview

Some embodiments provide an optical method of connecting memory to a processor that dramatically improves the trade-off in accessing memory and allows large amounts of low-density memory to be connected to high density logic on a different chip.

At a high level, the interface is comprised of many microLED—photodetector (PD) pairs providing point-to-point unidirectional optical links between two ICs. Each microLED—PD pair is coupled through an optical fiber. Each microLED has a switching speed on the order of GHz, similar to the switching frequency of digital logic but much slower than what would be required to carry the entire bandwidth of a memory bus. Because of this, many microLEDs and PDs are used to create a ‘wide’ bus with a large number of lanes, where each lane runs at the same frequency as the CPU or memory IC. Very many microLEDs and PDs may be implemented in a small area, with a typical pitch between the optical lanes of a few tens of microns providing a large bandwidth density of many Tb/s per mm\hat{ }2.

GaN LEDs are commonly used in artificial light sources due to their efficiency, spanning room-scale lighting to microLEDs for displays. This is mainly driven by their quantum efficiency: the proportion of electrons converted into photons. However, GaN LEDs have more recently been considered for data transmission, in which modulation speed becomes a key metric. Most LED structures are limited in their response time, as the carrier lifetime of the electrons and holes tends to be relatively long. Some microLEDs provide for high-speed operation with a relatively small penalty in efficiency. In some embodiments the microLEDs comprise: a p type GaN layer; an n type GaN layer; and a plurality of alternating quantum well layers and barrier layers between the type GaN layer and the n type GaN layer, with the quantum well layers being undoped and with the barrier layers being doped. In some embodiments some of the barriers are doped and some of the barriers not doped. In some embodiments, barriers closer to an n side of the active region of the LED are doped, and barriers closer to a p side of the active region of the LED are not doped. In some embodiments only a central portion of each barrier layer is doped. In some embodiments the doping in the barrier layers is p doping. In some embodiments the doping concentration for the doping in the barrier layers is at least 10¹⁹/cm³. In some embodiments the doping concentration for the doping in the barrier layers is at least 10²⁰/cm³. In some embodiments the doping in the barrier layers is with Mg. In some embodiments the p type GaN layer is doped with Mg. In some embodiments the n type GaN layer is doped with Si. In some embodiments, these microLEDs can provide transmit speeds of several GHz, greater than the typical clock speed of current logic, and so can directly interface with a memory bus. These LEDs therefore provide the transmitter of the optical system. In contrast to the lasers typically used for optical telecommunication, LEDs are incoherent sources. While this restricts the length of the interconnect due to the fundamentally spatially multimode output, it removes a need to drive the device above a lasing threshold, offering very low power operation.

These devices are generally fabricated on a sapphire substrate and lifted off and transferred onto a target wafer. The liftoff/transfer process is independent of the target wafer material and process. For example, a CMOS wafer could be used for direct integration of the microLEDs with logic or memory and fabricated with various process node technologies. This liftoff/transfer process has been developed by the microLED display industry for displays with >1 million microLEDs and is adopted here. It can readily provide an LED pitch of ˜50 um, or ˜400 devices per square millimeter. GaN has a large bandgap and so can emit small-wavelength light.

The devices in embodiments herein generally emit light near 420 nm, which corresponds to an absorption depth of 200 nm in silicon. Efficient photodetectors can therefore be implemented directly in CMOS, for example using an interdigitated design. In some embodiments the photodetector is in a CMOS device layer with the photodetector comprised of interdigitated p fingers and n fingers of a lateral p-i-n photodetector, the p fingers being connected to a p contact and the n fingers being connected to an n contact, the n fingers being doped with an n-type dopant and the p fingers being doped with a p-type dopant. In some embodiments a buried oxide layer is below the device layer. In some embodiments a buried doped layer is below the device layer. In some embodiments a p-type or n-type dopant implant is at at least one edge of the photodetector region. In some embodiments the buried oxide layer is reflective at a wavelength of operation. In some embodiments the wavelength of operation is about 450 nm. In some embodiments a thickness of the device layer is between 3 and 5 times an absorption length of light at the wavelength of operation. In some embodiments doped regions for the p fingers and the n fingers extend at least halfway through the thickness of the device layer. These photodetectors can be laid out in a grid that matches the 50 um pitch of the LEDs. Both LEDs and PDs generally require analog drive and readout circuitry, respectively, which is CMOS-compatible, and in some embodiments the circuitry is in the device layer. Due to the relatively low link speed per lane (˜10 GHz) compared to laser telecommunications (˜100 GHz) the drive and readout circuitry can be simple and low power. As both PDs and microLEDs can be transferred on a CMOS wafer (and the PD can also be monolithically integrated in the CMOS wafer), and the CMOS wafer may provide appropriate drive and readout circuitry, this optical interface can be used in a variety of chiplet or single die architectures.

A processor—memory interconnect may involve tens to hundreds or thousands of microLED—PD pairs. As both the processor and memory will generally both receive and transmit, the processor subsystem and memory subsystem will each include both microLEDs and PDs. Link frequency roughly matches the frequency of the memory interface, so no substantial SERDES will be used; however, in some embodiments, a SERDES that multiplexes/demultiplexes by a small integer factor, for instance a factor of 2 or 4, may be used. Each lane of the memory bus can be routed over a separate microLED and PD pair. The set of microLEDs and PDs (and drive and receive circuitry, respectively, associated with the microLEDs and PDs unless the context indicates otherwise) connected to a single region of a logic or memory IC may be hereafter referred to as a ‘microLED interface’. MicroLED interfaces are used to connect memory and logic ICs over optical fiber bundles. The latency associated with this link scales with approximately the speed of light. In contrast to the RC delay with dominates on-die interconnects, there is a very small penalty to creating long optical links. At 1 GHz, for example, a one clock cycle delay corresponds to a 20 cm long fiber.

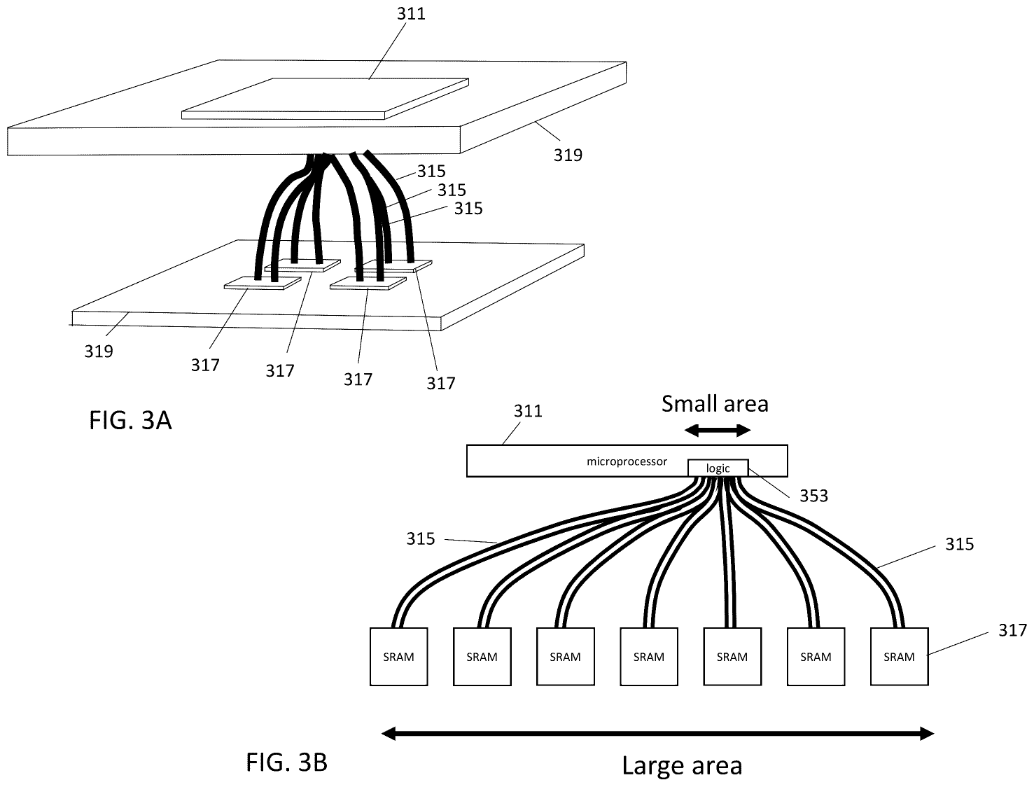

FIGS. 3A and 3B shows an example architecture in accordance with aspects of the invention. In FIGS. 3A and 3B, a processor is connected to external memory using this microLED technology to compensate for the different area and density between a logic chip and memory. Optical fibers may be fanned out from a small area on the processor or logic chip to cover a larger area. In FIGS. 3A and 3B, the processor chip 311 includes logic 353 for interfacing with memory in the form of SRAM. The SRAM is arranged as a plurality of chips 317, which may be on a different substrate 319 than a substrate 313 of the processor chip, or may arranged on a same substrate as the processor chip. The processor chip includes one or more array of microLEDs and PDs, as do the SRAM chips. Fibers 315 of a fiber bundle optically couple the microLEDs of the processor chip with PDs of the SRAM chips, and the microLEDs of the SRAM chips with PDs of the processor chip. In some embodiments the fiber bundle includes sub-bundles of fibers, and in some embodiments different ones of the sub-bundles optically couple different ones of the SRAM chips and the processor chip. In some embodiments, the fiber bundles and sub-bundles are butt-coupled to their associated microLEDs and PDs. In some embodiments, the fiber bundles and sub-bundles are coupled to their associated microLEDs and PDs using an optical coupling subassembly comprising one or more lenses and/or mirrors such that each microLED and each PD is imaged onto one fiber core.

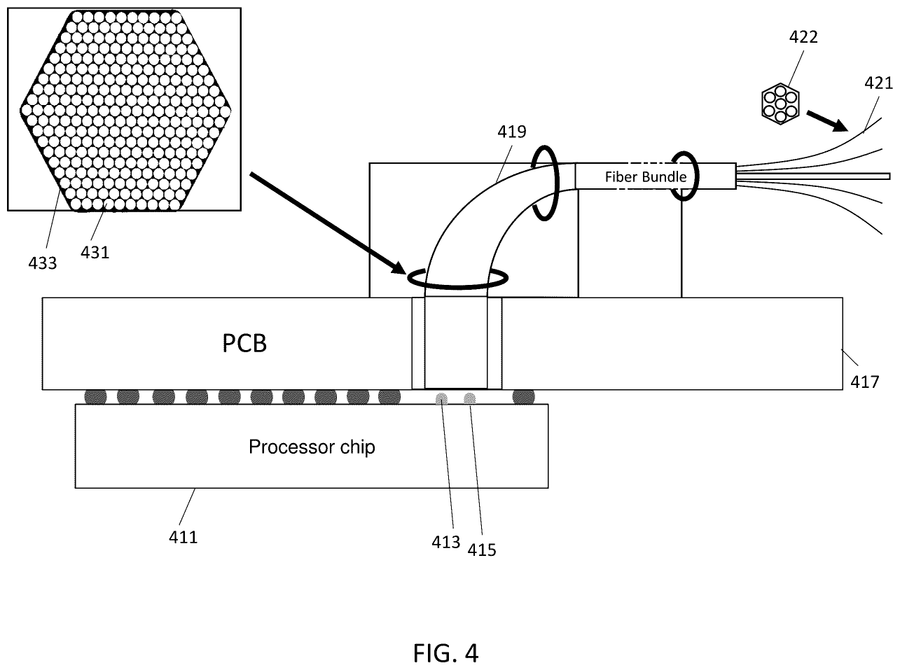

FIG. 4 illustrates an implementation of microLEDs 413 and PDs 415 on a processor die 411. LEDs are lifted off and mounted on the active side of the silicon processor die, which is flip-chip bonded to a PCB 417. This may be an organic interposer between several dies or a larger PCB. Both PDs and microLEDs are optically coupled to a fiber bundle 419 routed through an aperture of the PCB. The fiber bundle may be comprised of many sub-bundles, e.g., sub-bundle 421. An example cross-section 422 of sub-bundle 421 shows a plurality of optical fibers arranged in a hexagonal casing. The sub-bundles may each have several independent multimode fiber optic cables arranged in a regular pattern, in some embodiments epoxied together in a regular pattern. An inset shows a cross-section of a bundle 433 of 271 fibers, e.g., fiber 431, each with a 50 micron diameter. This larger array then breaks up into sub-bundles, which are coherent: the relative position of a cable at one end of a sub-bundle is maintained through the rest of the sub-bundle in some embodiments, or at an opposing end of the sub-bundle in some embodiments. In some embodiments, while relative positions of ends of fibers in a same sub-bundle are coherent, relative position of ends of fibers in different sub-bundles may not be coherent. A ferrule may be used to maintain alignment between each core of the fiber bundle and the microLEDs or PDs. The number of sub-bundles and the number of lanes included in each sub-bundle may be chosen to match the system architecture. In this case, several sub-bundles route to different memory modules, for example as is used in later examples.

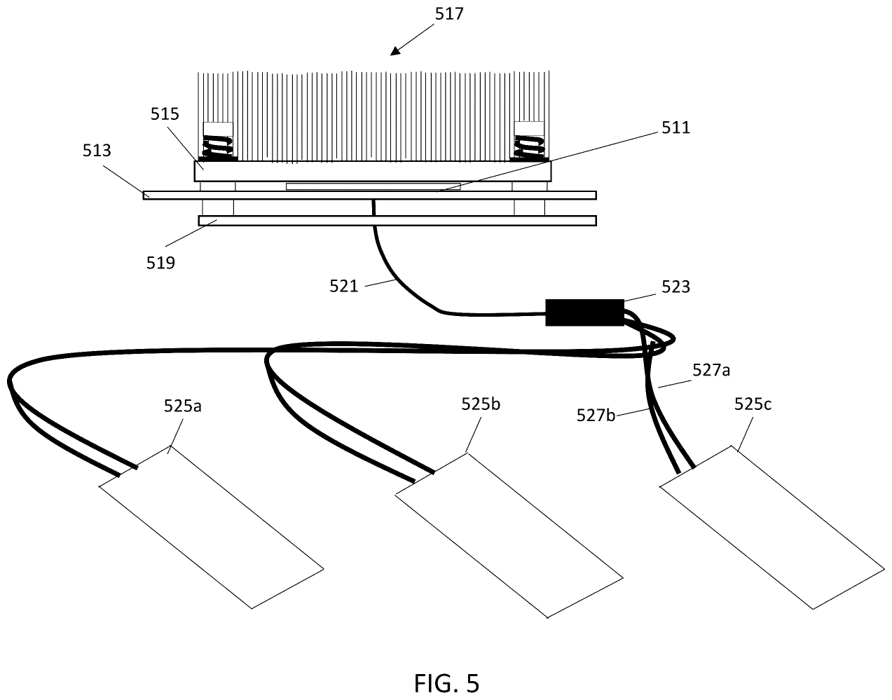

FIG. 5 illustrates an example system implementing this interconnect. Here, a processor 511 is flip-chip bonded to an organic package which is connected to a system PCB 513 through a ball grid array. A fiber bundle 521 is routed through holes in both the system PCB and organic package and ends of the fibers are butt-coupled to microLEDs and PDs on the surface of the processor or a logic IC packaged with the processor chip. In some embodiments the ends of the fibers may be optically coupled to the microLEDs and PDs in other means, for example with the ends of the fibers positioned to be optically coupled to the microLEDs and PDs using coupling optics, which may include one or more lenses and/or one or more mirrors. Note that the inactive surface of the logic die is unmodified, so this interface is compatible with standard cooling solutions, for example including a heatsink 515 and fins 517 as shown in FIG. 5. Fibers of the fiber bundle are routed to several memory modules 525a,b,c. Each memory module may be coupled to one or, as shown in FIG. 5, a pair of sub-bundles, with, e.g., memory module 525c coupled to fiber sub-bundles 527a,b. Each sub-bundle of the pair may provide communication in a different transmit/receive directions (as viewed by the memory module), as one possible implementation of this optical interconnect. In some embodiments the fiber bundle may be maintained as a single bundle for a predetermined length from the processor, and then broken out 523 into sub-bundles to go to the different memory modules. In some types of memory, the address/data-in and data-out regions exist on different regions of the die. The receive and transmit regions of the sub-bundle can be independently routed to the relevant die areas, eliminating or reducing the need for an electrical interconnect across a memory IC. In some embodiments this interface provides a highly parallel, long range, and low-latency link.

### Implementation in a CPU

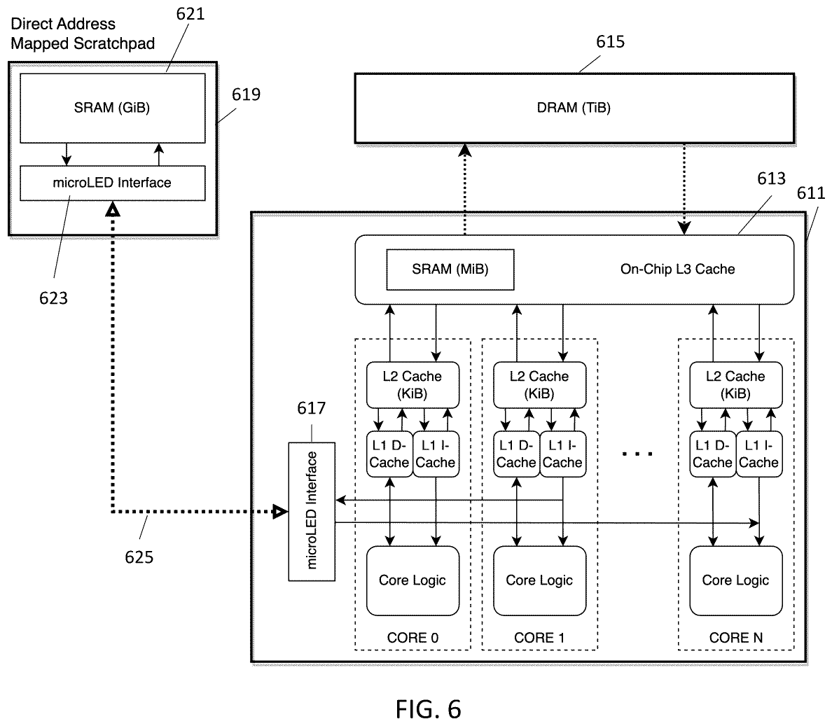

A highly parallel, low bandwidth, and low-latency optical interconnect may provide several implementations which address various issues. Most simply, a large, uniform, low-latency ‘scratchpad’ memory could provide large performance increases for applications that do not map well to the standard cache hierarchy. Using the interconnect discussed herein, such a memory may be implemented as a large off-chip SRAM. FIG. 6 presents an implementation of an architecture in which a GiB-scale SRAM is directly mapped to some subset of address space of or associated with a processor.

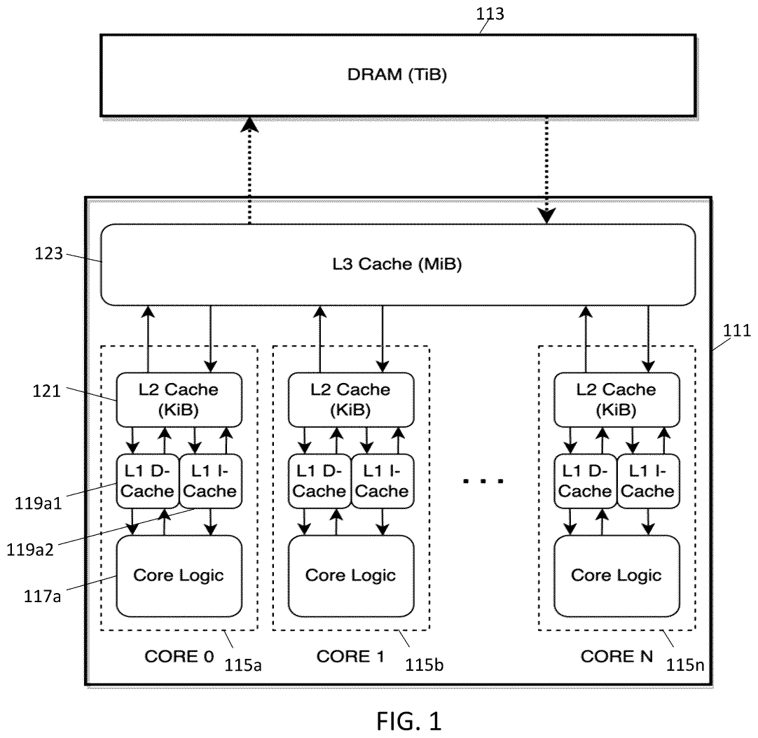

In FIG. 6, a processor chip 611 includes a plurality of processor cores and cache memory, as discussed with respect to FIG. 1. The processor chip is in electrical communication with memory, in the form of DRAM 615. The processor chip also includes a microLED interface 617. The microLED interface of the processor chip is optically coupled to a microLED interface 623 of a SRAM 621 memory module 619. The microLED interfaces may be optically coupled by a fiber bundle 625, which may include sub-bundles. The microLED interfaces may each include microLEDs, photodetectors, and drive and receive circuitry for the microLEDs and photodetectors, respectively.

In some embodiments the SRAM can be of arbitrary area, and low-density, low-latency cells can be used in some embodiments. As the interconnect is optical, latency is practically independent of interconnect length. Data is transferred at speed of light*velocity factor, so even a 10 cm link adds only 500 ps (˜1 cycle) latency. This provides substantial flexibility in the physical implementation of this SRAM, for example as discussed later in the text.

The address mapping can then be implemented in several ways. Most simply, the SRAM can bypass the cache hierarchy entirely, as is shown in FIG. 6, for example with the microLED interface of the processor chip directly coupled to the processor cores. Depending on the details of the SRAM cell configuration this may be undesirable—it is also possible to implement the SRAM after the on-chip cache, so it is treated identically to the rest of main memory.

While this approach may provide the lowest possible latency to a large off-chip memory, it also poses several challenges. Dividing main memory into a low-latency and high-latency regions may require low-level treatment by a programmer. For example, with the memory including low-latency and high-latency regions, the memory is no longer substantially completely uniform, as may be assumed by standard software packages.

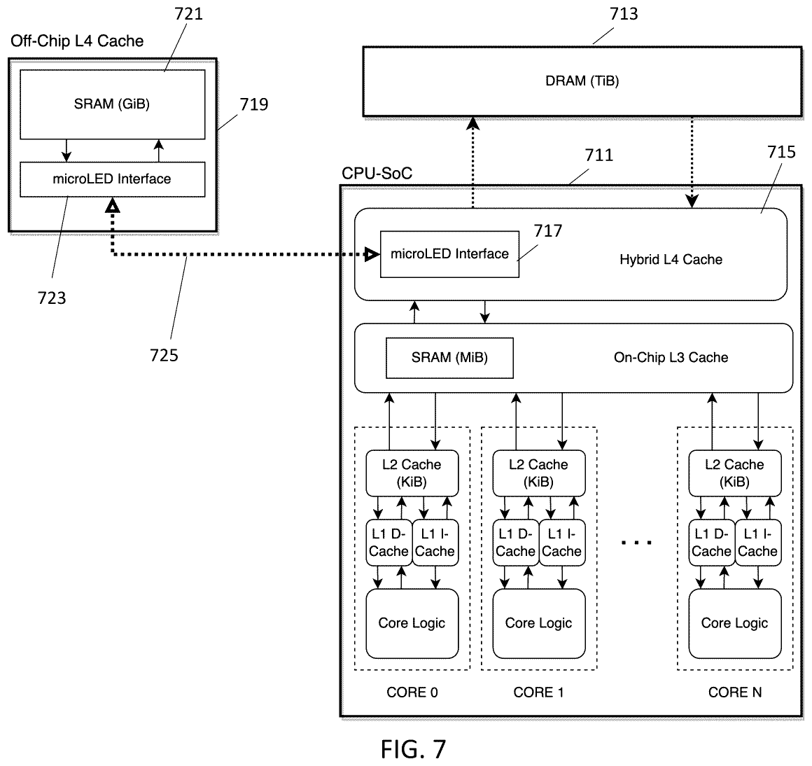

An alternative method of implementing a large off-chip SRAM into a traditional architecture is to place it within the cache hierarchy. A candidate architecture is shown in FIG. 7, with the SRAM introduced as a GiB-scale L4 cache. In FIG. 7, the processor chip is in electrical communication with memory, in the form of DRAM 713. The processor chip also includes a microLED interface 717. The microLED interface 717 is shown as forming part of a hybrid L4 cache 715. As with FIG. 6, the microLED interface of the processor chip is optically coupled to a microLED interface 723 of a SRAM 721 memory module 719. The microLED interfaces may be optically coupled by a fiber bundle 725, which may include sub-bundles. The microLED interfaces may each include microLEDs, photodetectors, and drive and receive circuitry for the microLEDs and photodetectors, respectively.

In general, caches use a TLB (Translation Lookaside Buffer) to map between physical and virtual addresses. As caches increase in size, the TLB increases in depth, adding latency. While in some embodiments the SRAM could be introduced as a cache at any level. The added latency will likely drive implementation to be at L3 or L4 of the cache hierarchy.

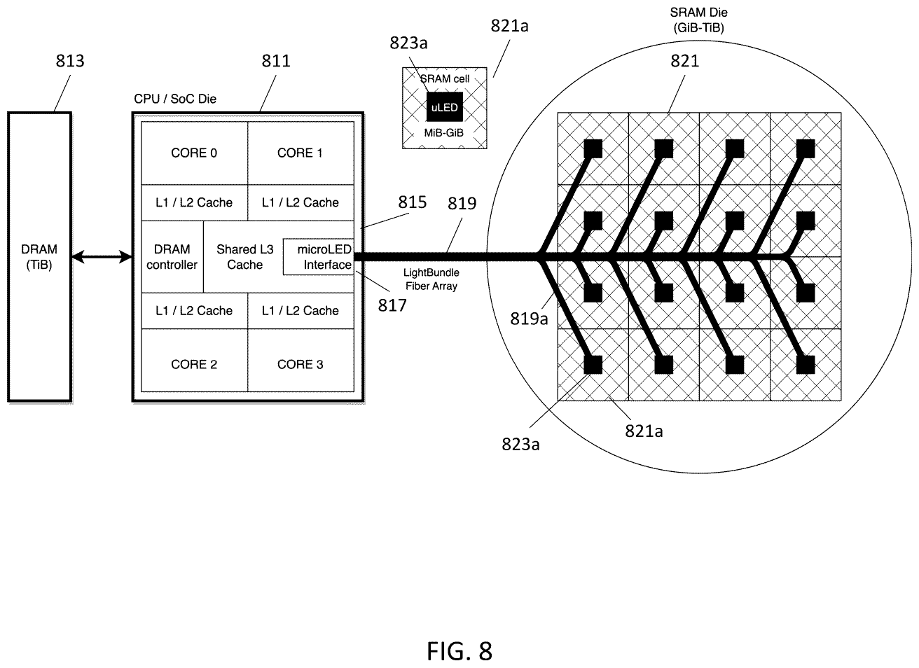

FIG. 8 illustrates an example physical implementation of an L3 SRAM cache. The implementation shown in the figure also generally applies to some embodiments of the ‘scratchpad’ architecture. FIG. 8 illustrates several aspects of the optical SRAM interface. In FIG.

8, a processor chip 811 includes multiple cores, and is coupled to DRAM 813. A shared L3 cache of the processor chip includes or has an associated microLED interface 817. The microLED interface is coupled to a fiber bundle 819, with sub-bundles of the fiber bundle coupled to different regions of a SRAM chip 821. The interface is very parallel, with 100 s or 1000 s of independent links carried on individual cores of imaging fibers. While each fiber is point-to-point, a bundle of fibers can be split. In FIG. 8, a large bundle of fibers fans out across a large SRAM die. Each sub-bundle of the bundle interfaces with an independent region ('cell') of SRAM, for example with a capacity of MiB-GiB. For example, sub-bundle 819a is shown as interfacing with a cell 821a of the SRAM chip. The interface of the cell of the SRAM chip may be a microLED interface. Each ‘cell’ has an associated array of microLEDs and detectors as well as, in various embodiments, an alignment mechanism for an imaging fiber sub-bundle. On a read cycle, logic of the cell receives a memory request from the main processor chips via the integrated photodetectors and amplifiers, then accesses the local memory bus, retrieves the data from the SRAM cells, then drives the microLEDs that are coupled to the fiber bundles to transmit the information. On a write cycle, the cell similarly receives the request optically, and writes the information to the local memory cells. The read and write operates can be serialized and de-serialized if demanded by the architecture.

Because each cell of SRAM operates independently, no cross-cell connections are necessary, and the maximum electrical interconnect length may be capped at one half of the cell dimension. This scheme therefore removes or reduces the latency and power penalties of addressing a large SRAM using long electrical interconnects. The speed-of-light delay between SRAM ‘cells’ is negligible. The size of this SRAM is limited by the number of fiber bundles (number of lanes) and the number of SRAM ‘cells’ (die area). In principle, it could be scaled to an entire wafer: for example, assuming ˜0.03 square microns for an SRAM bit, this wafer could be on the order of 300 GB of memory. Wafer based packaging could be used to realize the packaging of many fibers across the large silicon wafer.

### Implementation in an Accelerator

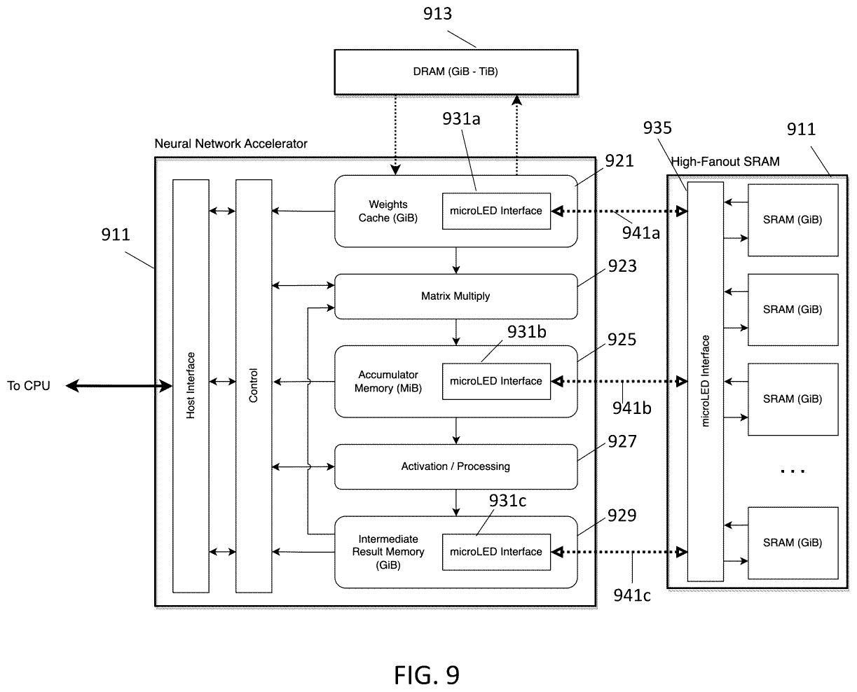

The optically addressed SRAM can be used in other types of logic. For example, in some embodiments the scratchpad and cache expansion are implemented into a GPU or a DPU. The optically addressed SRAM is also applicable to specialized accelerator architectures. As is discussed earlier, matrix multiplies form an important workload in AI, and may be ill-suited to traditional, general-purpose computer architectures. FIG. 9 shows an architectural view of a simple neural network (NN) accelerator implementing an external optically addressed SRAM. In general, training and inference involves matrix multiplication, followed by accumulation, activation, and normalization. Current neural network architectures are typically composed of ‘layers’ of networks, where the output of a single layer (matrix multiplication) is fed into computation of the next layer output.

A datapath for accelerating these workloads is shown in the figure. In FIG. 9 a neural network chip 911 has an interface with a CPU, a DRAM 913, and a SRAM 911, shown as a high fanout SRAM. The interface with the SRAM is an optical interface. As in embodiments discussed in prior figures, the optical interface includes NN-side microLED interfaces 931a,b,c coupled to at least one SRAM-side microLED interface 935 by one or more fiber bundles 941a,b,c. A matrix multiplier 923 of the NN is fed by two sources: a large memory containing training ‘weights’, and an ‘intermediate result’ memory 929 storing the outputs of previous computations. An accumulator 925 is used to reduce the dimensionality of the multiplier output, and a custom arithmetic logic unit 927 applies the activation function and normalization specified by the network. Such a datapath is exemplary only, other datapaths, and more detailed datapaths may be utilized. Off-chip SRAM, however, may be used with the exemplary data path, or other data paths, and is applicable to many types of network acceleration. Similarly, an off-chip SRAM could be used for NN accelerators implemented on a CPU die, co-packaged with a CPU, or connected via a bus such as PCIe, with small differences in packaging.

There are generally three memories which may be used in a NN accelerator. First, memory may be used to store the computation weights. This is typically external—modern networks can have >200e9 parameters (˜1 TiB), generally much too large to fit on any on-chip memory. Second, memory 931 may be used to store accumulation results. This memory generally can be relatively small, on the order of MiB-GiB, and so has historically been included on accelerator dies. Lastly, networks may use memory to store intermediate results for piecewise matrix multiplication or computation of interconnected layers. This memory is relatively large, and is generally preferred to be very low-latency. Because of this, it is typically implemented as on-chip SRAM, which may have a very large physical footprint. Furthermore, the total size of this buffer is restricted by chip area: generally only <100 MiB memories will fit in the footprint of a modern logic die. However, as networks scale in size and complexity, larger intermediate result memories may become more useful.

FIG. 9 illustrates use of a large off-chip, high-fanout SRAM optically coupled to the NN accelerator. The use of a large off-chip, high-fanout SRAM optically coupled to the NN accelerator in some embodiments provides a solution to the memory bottleneck in NN accelerators. In FIG. 9, a microLED/PD interface 931a,b,c to the SRAM is implemented at three points in the datapath. First, the SRAM provides a large cache for model weights. As the SRAM could in principle be scaled to 100 s of GiB, this cache could store the entire set of weights for a small model, reducing or possibly eliminating the need for DRAM for storing the weights altogether. Second, the SRAM moves the accumulator memory, in whole or in part, off-die. Third, the SRAM moves the intermediate result memory, in whole or in part, off-die. As these two memories typically consume a large portion of die area, using off-chip SRAM allows for larger multipliers as well as a larger memory capacity for future models. These memories could of course be implemented with additional on-chip caches if the application requires very low latency.

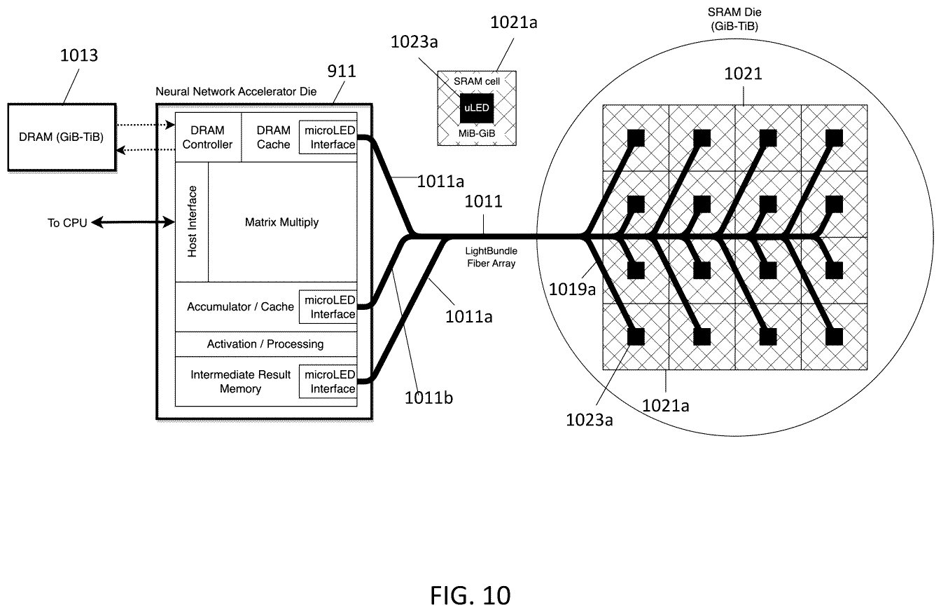

FIG. 10 illustrates an example implementation of a SRAM, along with the NN accelerator. In FIG. 10, a single fiber bundle 1011 optically couples microLED interfaces of an NN accelerator die 911 with the SRAM 1021. Sub-bundles 1011a,b,c of the fiber bundle are coupled to different ones of the microLED interfaces of the NN accelerator. On the SRAM side, sub-bundles, for example sub-bundle 1019a, are coupled to different memory regions of the SRAM, for example region 1021a which include a microLED interface 1023a. The sub-bundles on the SRAM side are, in some embodiments, subsets of sub-bundles on the NN side. Several aspects of the optical memory interconnect are demonstrated here. As in the scratchpad/cache example, a high-fanout SRAM provides a large, low-latency memory that can be scaled across an entire wafer. MicroLED interfaces scattered across the SRAM die ensure low latency and effectively constrain electrical interconnect length. For the NN accelerator, multiple microLED interfaces are on the logic die. While this adds packaging complexity, it can provide power and performance improvements by the elimination of the long high-frequency electrical interconnects, for example to a single microLED interface, which typically dominate logic power. In some embodiments the use of multiple microLED interfaces is also implemented in the SRAM cache/scratchpad, for example by including optical interfaces near the regions of the die dedicated to individual cores.

### Implementation in a Many-to-One Memory

The optical-memory interface is not restricted to logic-SRAM connections within a single system. Given the large increase in interconnect distance that the optical interface offers over electrical links, while providing a wide bus that can integrate directly with a CPU, in some embodiments this interface is used to allow several CPUs to natively address the same memory. At a high level, this provides similar capability to a multi-socket server, in which several CPU packages can access the same memory, but this could be expanded to rack-scale without the disadvantages of non-uniform memory access (NUMA) which is typical in multiprocessor systems.

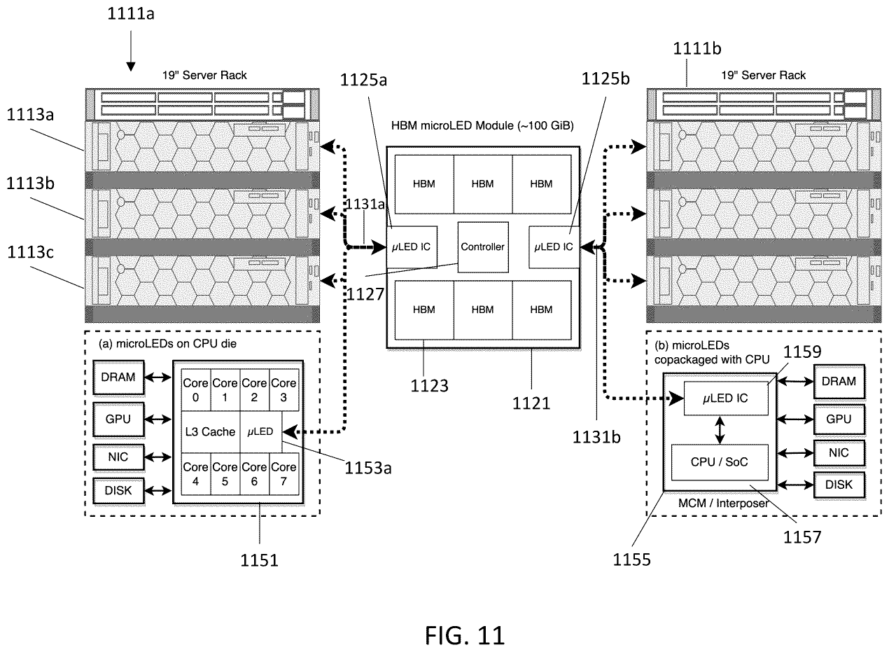

An example of this is shown in FIG. 11. In FIG. 11, each CPU package is represented as a server 1113a,b,c in a 19″ server rack, with its own DRAM and peripherals, but in some embodiments the servers are multiple-CPU servers. Each CPU package includes a microLED interface 1153a or 1159 optically coupled by a fiber bundle 1131a,b or sub-bundle to a module 1121 including high bandwidth memory 1123 and microLED interfaces 1125a,b. In addition, some embodiments also use optically addressed SRAM as external cache or scratchpad, for example in parallel to the optical scheme of FIG. 11. There are several possible microLED-CPU interfaces. In some embodiments the microLEDs and PDs are integrated on the CPU die, for example as is shown with microLED interface 1153a integrated on a CPU die 1151. In some embodiments the microLEDs and PDs are on a separate chiplet 1159 which is co-packaged 1155 with the CPU die 1157. This many-to-one optical interconnect addresses, in various embodiments, a variety of memory systems, such as a wafer-scaled shared SRAM or a set of DRAM dies. The latter is chosen here for illustration—a microLED interface is implemented with several stacks of HBM memory as well as a controller which handles the many-to-one logic. This is an arbitrary choice—other memory types could instead be illustrated, albeit in some instances with modification of the controller logic depending on the memory selected.

### Choice of Memory Cell

The above discussion has focused primarily on optically addressed SRAM, as it has the lowest density and the best intrinsic latency. It is thus perhaps ideally suited to the optical approach discussed above. By breaking out the bundles to different locations on the memory, the density problem may be reduced or eliminated without adding significant latency. However, this optical approach generally can be used with other memory or logic technology. For example, the same approach could be followed with DRAM. A microLED optical interface could be implemented on DRAM wafers, with sub-bundles going to different locations on the memory. If multiple DRAM wafers are stacked vertically on top of a controller chip, as is done with HBM, then the microLED interface may be realized on the controller chip. Sub-bundles could go to different HBM stacks. Though the intrinsic latency of DRAM would remain, in many embodiments negligible latency is added for moving the information from the DRAM stacks to the processor if we using the microLED interface discussed herein.

Similarly, the microLED interface may used as interconnects between processor chips optimize for different functions. For example, one chip may be optimized for matrix multiplication, while another chip may be optimized for accumulation. The two chips may then be connected by a mesh of fiber bundles that would pair each multiplier to each accumulator.

The fiber bundles, instead of simply dividing out, with different sub-bundles going to different locations, may also incorporate splitters in some embodiments. This allows for the same data to be transmitted by microLEDs, but received by multiple detectors. This splitting function is useful for matrix multiplication and can be done optically much easier than electrically.

Alternatively, active switch ICs may be implemented between sub-bundles forming a network. Thus packets of information could be addressed between sub-bundles. A format such as CXL or PCIE may be used for a switched network of fiber bundles.

In summary, the above discusses, for example, methods of and devices for optically connecting large amounts of memory to processors or XPUs using fiber bundles and microLEDs/PDs. Splitting the bundles allows for solving the problem of different densities between memory and logic.

Although the invention has been discussed with respect to various embodiments, it should be recognized that the invention comprises the novel and non-obvious claims supported by this disclosure.

What is claimed is:

1. A system including a memory optical interconnect, comprising:
a processor chip including logic for interfacing with memory;
a first array of microLEDs on the processor chip;
a first array of photodetectors on the processor chip;
a plurality of memory chips; and
a fiber bundle including a plurality of sub-bundles of fibers, with the fibers of some of the sub-bundles optically coupled to the first array of microLEDs and fibers of others of the sub-bundles optically coupled to the first array of photodetectors, and with fibers of different ones of the sub-bundles optically coupling different ones of the memory chips and the processor chip.

2. The system of claim 1, wherein the memory chips comprise static random-access memory (SRAM) chips.

3. The system of claim 1, wherein the processor chip is mounted to a substrate, with the fiber bundle routed through an aperture in the substrate.

4. The system of claim 3, wherein the first array of microLEDs and the first array of photodetectors are on an active surface of the processor chip.

5. The system of claim 4, wherein a heatsink and cooling fins are coupled to an inactive surface of the processor chip.

6. The system of claim 1, wherein fibers of two different sub-bundles optically couple each memory chip and the processor chip.

7. The system of claim 2, wherein a first of the two different sub-bundles provides for communication in a first transmit/receive direction and a second of the two different sub-bundles provides for communication in a second transmit/receive direction.

8. The system of claim 1, wherein the processor chip and the memory chips are on different substrates.

9. A system including a processor optically connected to memory, comprising:
a processor chip including a plurality of processor cores, cache memory for each processor core, shared cache memory for the processor cores, and a first microLED interface;
at least one first memory electrically coupled to the processor chip;
at least one second memory electrically coupled to a second microLED interface;
the first microLED interface and the second microLED interface each comprising microLEDs, drive circuitry for the microLEDs, photodetectors, and read-out circuitry for the photodetectors; and
at least one optical fiber bundle, the at least one optical fiber bundle coupling the microLEDs of the first microLED interface with photodetectors of the second microLED interface and coupling the microLEDs of the second microLED interface with photodetectors of the first microLED interface.

10. The system of claim 9, wherein the second memory is directly mapped to a subset of address space of the processor core.

11. The system of claim 9, wherein the first memory comprises dynamic random-access memory (DRAM) and the second memory chip comprises static random-access memory (SRAM).

12. The system of claim 9, wherein the first microLED interface of the processor chip is coupled to the processor cores such that processor core access to the second memory bypasses a hierarchy defined by the cache memory and shared cache memory of the processor chip.

13. The system of claim 9, wherein the first microLED interface of the processor chip is coupled to the processor cores by way of the cache memory and the shared cache memory of the processor chip.

14. The system of claim 13, wherein the first microLED interface of the processor chip is coupled to the shared cache memory of the processor chip.

15. The system of claim 14, wherein the at least one optical fiber bundle includes a plurality of sub-bundles, each sub-bundle including fibers interfaced with an independent region of the second memory.

16. A neural network accelerator memory interconnect, comprising:
a plurality of first microLED interfaces on a neural network (NN) accelerator chip, the accelerator chip comprising a host interface for communication with a central processing unit (CPU) and blocks for performing matrix multiplication and arithmetic logic unit;
at least one second microLED interface coupled to memory external to the NN accelerator chip;
with the plurality of first microLED interfaces and the at least one second microLED interface each comprising microLEDs, drive circuitry for the microLEDs, photodetectors, and read-out circuitry for the photodetectors; and
at least one optical fiber bundle, the at least one optical fiber bundle coupling the microLEDs of the plurality of first microLED interfaces with photodetectors of the at least one second microLED interface and coupling the microLEDs of the at least one second microLED interface with photodetectors of the plurality of first microLED interfaces.

17. The neural network accelerator memory interconnect of claim 16, wherein a first of the plurality of first microLED interfaces is associated with computation weights, a second of the plurality of first microLED interfaces is associated with results of matrix multiplication by the NN accelerator chip, and a third of the plurality of first microLED interfaces is associated with intermediate results determined by the NN accelerator chip.

18. A many-to-one high bandwidth memory interconnect, comprising:
a plurality of first microLED interfaces coupled to a plurality of CPUs, with at least one of the plurality of first microLED interfaces packaged on or with each CPU die;
at least one second microLED interface coupled to high bandwidth memory external to the CPU die;
with the plurality of first microLED interfaces and the at least one second microLED interface each comprising microLEDs, drive circuitry for the microLEDs, photodetectors, and read-out circuitry for the photodetectors; and
at least one optical fiber bundle, the at least one optical fiber bundle coupling the microLEDs of the plurality of first microLED interfaces with photodetectors of the at least one second microLED interface and coupling the microLEDs of the at least one second microLED interface with photodetectors of the plurality of first microLED interfaces.
